(19) United States
(12) Patent Application Publication
(10) Pub. No.: US 2022/0195913 A1
(43) Pub. Date: Jun. 23, 2022

(54) AIR FEED SYSTEM FOR AN INTERNAL COMBUSTION ENGINE

(71) Applicant: ABB Switzerland Ltd., Baden (CH)

(72) Inventors: Christoph Mathey, Fislisbach (CH); Raphael Ryser, Baden (CH)

(21) Appl. No.: 17/599,072

(22) PCT Filed: Mar. 26, 2020
(86) PCT No.: PCT/EP2020/058580

§ 371 Date: Sep. 28, 2021

(30) Foreign Application Priority Data
Mar. 29, 2019 (EP) 19166331.9

(51) Int. Cl. F02B 33/44; F02D 41/00; F02B 37/02; F02D 41/06

(52) U.S. Cl. CPC F02B 33/446; F02D 41/062; F02B 37/02; F02D 41/0007

(57) ABSTRACT

Described herein is an air feed system for an internal combustion engine. The air feed system includes a charge air receiver for receiving charge air and a starting air system. The starting air system is designed to feed starting air, in particular from a starting air feed, to the cylinder of the internal combustion engine intermittently during a starting process of the internal combustion engine. The charge air receiver is connected to the starting air system via a charge air shut-off valve in order to feed charge air from the charge air receiver to the starting air system during partial-load operation of the internal combustion engine, such that the starting air system feeds charge air to the cylinder intermittently during partial-load operation of the internal combustion engine. Also described herein are an internal combustion engine and a method for operating an internal combustion engine.

### CROSS-REFERENCE TO RELATED APPLICATIONS

This application is the U.S. National Stage Application of International Patent Application No. PCT/EP2020/058580, filed Mar. 26, 2020, which claims the benefit of priority to European Patent Application No. 19166331.9, filed Mar. 29, 2019, each of which is hereby incorporated by reference herein.

### TECHNICAL FIELD

The present disclosure is directed generally to an air feed system for an internal combustion engine, an internal combustion engine, and a method for operating an internal combustion engine.

### BACKGROUND

Internal combustion engines, in particular large engines in the medium-fast running segment, are today increasingly being equipped with so-called Miller valve timing and highly efficient high-pressure charging. The timing cycles are characterized in that the inlet valve closes before bottom dead center. This design firstly leads to a fall in fuel consumption, and due to internal expansion the NOx emissions are substantially reduced; however, on the other hand, the behavior during starting, acceleration and partial load operation is negatively influenced.

Because of extreme Miller valve timing, the mass entering the cylinder at idle is so small that in a diesel engine, the necessary combustion temperature is not reached in the compression phase and hence starting of the engine is not possible. In addition, the filling is so low over a large range of partial load operation that smoke-free combustion with acceptable exhaust gas temperatures can no longer be guaranteed.

In gas engines with Miller valve timing, the low temperature at the end of the compression phase has a negative effect on combustibility and hence the running behavior of the engine. In general, the Miller timing cycle can negatively influence the acceleration behavior and response. In addition, at idle and low load operation, operating states may occur in which an undesirable negative pressure fall is created between the space above and below the piston.

As a counter-measure to the partially unsatisfactory operating behavior of internal combustion engines with Miller valve timing at low loads, today various technologies are used. Some of these technologies are aimed for example at changing the inlet valve closure during partial load operation.

In view of the above, there is a need for further improvement.

### SUMMARY

According to one embodiment, an air feed system is provided for an internal combustion engine, in particular for an internal combustion engine with Miller timing cycle. The air feed system has a charge air receiver for receiving charge air, and a starting air system. The starting air system has a starting air supply line connected to a cylinder of the internal combustion engine. Furthermore, the starting air system is configured to feed starting air, in particular from a starting air feed, intermittently to the cylinder of the internal combustion engine during a starting process of the internal combustion engine. The charge air receiver is connected to the starting air system via a charge air shut-off valve in order to feed charge air from the charge air receiver to the starting air system during partial load operation of the internal combustion engine, so that the starting air system feeds charge air intermittently to the cylinder via the starting air supply line on partial load operation of the internal combustion engine.

According to one embodiment, an internal combustion engine is provided, in particular an internal combustion engine with Miller timing cycle. The internal combustion engine has an air feed system according to one of the embodiments disclosed herein. The internal combustion engine furthermore has a cylinder, wherein the starting air system is connected to the cylinder in order to feed starting air intermittently to the cylinder of the internal combustion engine during a starting process of the internal combustion engine. The internal combustion engine has a compressor, in particular a turbocharger device, which is connected to the charge air receiver for feeding charge air to the charge air receiver.

According to one embodiment, a method is disclosed for operating an internal combustion engine, in particular an internal combustion engine with Miller timing cycle, wherein the internal combustion engine has a starting air system according to an embodiment as disclosed herein. The method comprises starting the internal combustion engine in that the starting air system supplies starting air intermittently to a cylinder of the internal combustion engine. The method furthermore comprises feeding charge air from the charge air receiver to the starting air system during partial load operation of the internal combustion engine, so that the starting air system feeds charge air intermittently to the cylinder.

### BRIEF DESCRIPTION OF THE FIGURES

The present disclosure is described in more detail below with reference to embodiments, without these restricting the scope of protection defined by the claims.

The appended drawings illustrate embodiments and, together with the description, serve to explain the principles of the present disclosure. The elements of the drawings are relative to each other and not necessarily true to scale. Correspondingly, the same reference signs designate similar parts.

In the drawings:

FIG. 1A shows an air feed system for an internal combustion engine according to one embodiment.

FIG. 1B shows an air feed system for an internal combustion engine according to one embodiment.

FIG. 2 shows an air feed system for an internal combustion engine according to one embodiment.

FIG. 3 shows an air feed system for an internal combustion engine according to one embodiment.

### DETAILED DESCRIPTION

According to one embodiment, an air feed system for an internal combustion engine is provided. This may include an internal combustion engine with Miller timing cycle. In particular, an air feed system for combined feed of charge air and starting air to an internal combustion engine is provided.

The air feed system has a starting air system 10. The starting air system 10 may be used advantageously in particular during the starting process of the internal combustion engine. The starting air system allows compressed air, referred to below as starting air, to be conducted at increased pressure into a cylinder, in particular into the combustion chamber, of the internal combustion engine, wherein one or more pistons of the internal combustion engine are set in rotation so that a fuel supply engages and the engine can be started.

The starting air system 10 has a starting air supply line 7. The starting air supply line 7 is connected to the cylinder of the internal combustion engine. The internal combustion engine may have a multiplicity of cylinders, wherein the starting air system 10 may be connected across all cylinders via the starting air supply line 7. The starting air supply line 7 may be a braided line set and/or a multiplicity of lines. The starting air system 10 is configured to feed starting air intermittently to the cylinder of the internal combustion engine during a starting process of the internal combustion engine.

According to one aspect, the intermittent feed comprises a periodic sequence of feed time intervals in which the starting air is fed to the cylinder via the starting air supply line, with blocking intervals in between, during which the feed is interrupted. The intermittent feed may take place periodically and in synchrony with actuation of an inlet valve of the internal combustion engine (with a period which is a constant multiple of the period of actuation of an inlet valve, i.e. approximately the same period or half or twice the period of actuation of an inlet valve).

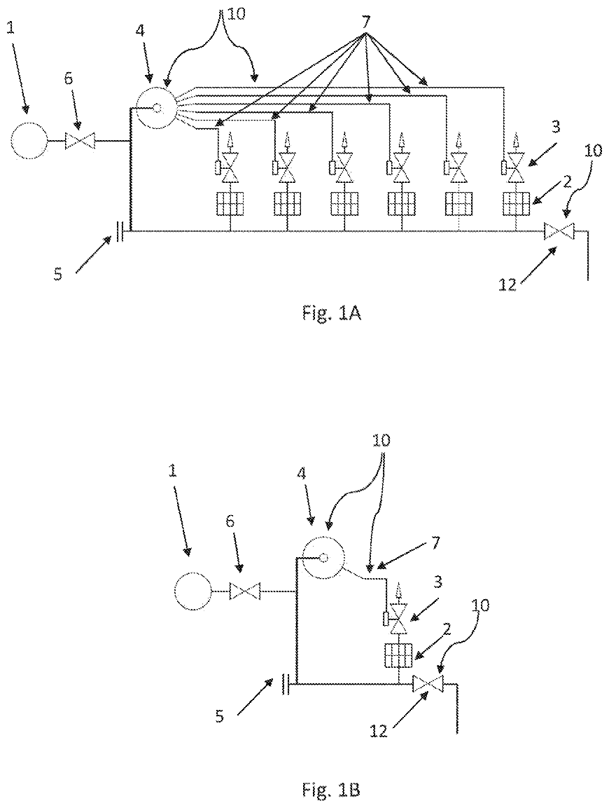

The starting air supply line 7 may be mechanically connected to the cylinder head. FIGS. 1A, 1B, 2 and 3 show exemplary embodiments of the starting air system 10 and the starting air supply line 7.

The starting air supply line is provided in addition to the inlet of the air fuel mixture via the inlet valve. Furthermore, the starting air supply line has a starting gas input, or also a starting gas inlet to the cylinder, which is separate from the inlet valve. Typically, the starting air supply line is not fluidically connected to an inlet line or intake manifold of the internal combustion engine.

The starting air system may also be regarded as a compressed air starter. The starting air system allows a direct infeed of starting air into the cylinder of the internal combustion engine during a starting process of the internal combustion engine.

Advantageously, the starting air system 10 according to the present disclosure allows a very rapid starting process, for example within a few seconds or even less than one second. In contrast to conventional starters that are connected to an inlet line or intake manifold, according to the present disclosure it is typically not provided to feed the starting air into all cylinders of the internal combustion engine, but an infeed may take place into one or few cylinders, for example two cylinders. Typically, the starting air is conventional air or nitrogen, and not exhaust gas air or gases of a fuel for the internal combustion engine.

The starting air system 10 may be connected to a starting air feed. Typically, the starting air feed is a compressed gas cylinder or pressure vessel. The starting air system 10 may be configured to feed starting air from the starting air feed intermittently to the cylinder of the internal combustion engine during a starting process of the internal combustion engine. Typically, the starting air may have a pressure around 30 bar.

The starting air system 10 may have a starting air shut-off valve 12. The starting air shut-off valve 12 may be actuated so as to open the feed of starting air during a starting process of the internal combustion engine, and in particular to open the connection of the starting air feed to the starting air system 10. During partial load operation, and in particular in full load operation of the internal combustion engine, the feed of starting air to the starting air system 10 may be blocked. FIGS. 1A, 1B, 2 and 3 show exemplary embodiments of the starting air shut-off valve 12. In general, the starting air system is configured to shut off the supply of starting air in normal operation (e.g. after the starting process), for example by blocking of the starting air shut-off valve 12.

The starting air system 10 may furthermore comprise a starting air valve 3 arranged in the starting air supply line 7. In particular, the starting air valve 3 may be arranged upstream of the cylinder of the internal combustion engine. If the starting air supply line 7 is mechanically connected to the cylinder head, the starting air valve 3 may be mechanically connected to the cylinder head. In some embodiments, the starting air valve 3 fulfils the purpose of preventing the flow of air or gas from the cylinder of the internal combustion engine towards the starting air system 10. In such cases, the starting air valve 3 may be a check valve. In some other embodiments, the starting air valve 3 fulfils additional functions, as will be explained in the further course of the description. In particular, in such cases a starting air valve 3 may be used which is configured to allow or block the flow of air or gas in two directions (from the cylinder towards the starting air system 10, and from the starting air system 10 towards the cylinder). For example, in such cases the starting air valve 3 may be an electromagnetic switching valve. FIGS. 1A, 1B, 2 and 3 show example embodiments of the starting air valve 3.

In one embodiment, the starting air system 10 may have a starting air distributor 4. The starting air distributor 4 may be connected to the starting air supply line 7. In the case that the internal combustion engine has one cylinder, the starting air supply line 7 may comprise one line, and the starting air distributor 4 may be connected to this line of the starting air supply line 7. An embodiment of the air feed system for an internal combustion engine having one cylinder is shown for example in FIG. 1B. In the case that the internal combustion engine has a multiplicity of cylinders, the starting air supply line 7 may also have a multiplicity of lines, wherein the starting air distributor 4 may be connected to all of the multiplicity of lines of the starting air supply line 7. An embodiment of the air feed system for an internal combustion engine having a multiplicity of cylinders is shown as an example in FIG. 1A. According to one embodiment, the starting air distributor 4 may be a rotating shaft with one or more openings which in particular are driven in synchrony with the crankshaft of the internal combustion engine (where applicable with a fixed translation ratio, such as a translation ratio of 1:1 or 1:2). The starting air distributor 4 may be configured for the intermittent feed of starting air, in particular from the starting air feed, to the cylinder via the starting air supply line 7.

FIGS. 1A, 1B, 2 and 3 show schematic embodiments of the air feed system, in particular the starting air system 10. In the figures, the cylinder of the internal combustion engine is not shown. The flow of starting air (and charge air, as will be explained later) to the cylinder of the internal combustion engine is indicated by the arrow on the upper portion of the starting air valve 3.

The air feed system furthermore has a charge air receiver 1 for receiving charge air. Charge air receivers as such are known to the person skilled in the art. A charge air receiver 1 is a pressurized chamber in which a positive pressure prevails. In some embodiments, the positive pressure in the charge air receiver 1 may be generated by a compressor, in particular by a turbocharger device. The compressor, in particular the turbocharger device, may be connected to the charge air receiver for feeding charge air to the charge air receiver 1.

The charge air receiver 1 is connected to the starting air system 10 via a charge air shut-off valve 6 in order to feed charge air from the charge air receiver 1 to the starting air system 10 during partial load operation of the internal combustion engine. The charge air may thus be fed intermittently from the charge air receiver 1 to the starting air system 10, and from the starting air system 10 by means of the starting air supply line 7 to the cylinder of the internal combustion engine. In one example embodiment, the intermittent feed of charge air takes place during partial load operation of the internal combustion engine.

The charge air shut-off valve 6 may be actuated so as to block a feed of charge air to the starting air system 10 during a starting process, in particular at full load operation of the internal combustion engine. During partial load operation of the internal combustion engine, in some embodiments, the feed of charge air from the charge air receiver 1 to the starting air system 10 is open. FIGS. 1A, 1B, 2 and 3 show example embodiments of the charge air shut-off valve 6.

The feed of starting air, in particular during the starting process of the internal combustion engine, and the feed of charge air, in particular during partial load operation of the internal combustion engine, may take place at defined times within a working cycle of the internal combustion engine. In other words, the feed of starting air and charge air may take place at a defined position (or different times in the opening/closing phase) of an inlet valve of the internal combustion engine, or at a defined rotational angle of a crankshaft of the internal combustion engine.

In one embodiment, the starting air system 10 is configured for the intermittent feed of starting air and charge air to the cylinder depending on the rotational angle of the crankshaft of the internal combustion engine. The starting air system 10 may be configured to allow the feed of charge air to the cylinder during or after an opening of the inlet valve of the internal combustion engine. The starting air system 10 may be configured to block the feed of charge air to the cylinder before or on reaching a rotational angle of the crankshaft of 30°, or, in some embodiments, 20° after a bottom dead center.

The feed of starting air, in particular during the starting process of the internal combustion engine, and the feed of charge air, in particular during partial load operation of the internal combustion engine, may take place at different times within a working cycle. In other words, the intermittent feed of charge air by the starting air system 10 may take place at a different rotational angle of the crankshaft than the starting air. The starting air system 10 may intermittently feed the charge air in a first rotational angle range of the crankshaft, and/or the starting air in a second rotational angle range of the crankshaft. The first rotational angle range may differ from the second rotational angle range.

Various features of the starting air system 10 may be configured to allow an intermittent feed of charge air and/or starting air, and in particular to allow the intermittent feed of charge air by the starting air system 10 at a different rotational angle of the crankshaft than the starting air. Some of these embodiments are described below with reference to the figures. The features of these embodiments may however be combined arbitrarily.

According to one embodiment, the charge air receiver 1 may be connected to the starting air distributor 4 via a charge air supply line. FIGS. 1A and 1B show embodiments in which the charge air receiver 1 is connected to the starting air distributor 4. In one example embodiment, the charge air shut-off valve 6 is provided in the charge air supply line. The starting air distributor 4 may be configured for the intermittent feed of starting air and charge air to the cylinder. According to one embodiment, the starting air distributor may be a rotating shaft with an opening, which in particular is driven in synchrony with the crankshaft of the internal combustion engine, wherein the starting air and/or charge air are fed intermittently when an overlap exists between the opening of the rotating shaft and the starting air supply line 7. In the case of several cylinders and several lines of the starting air supply line 7 (as shown for example in FIG. 1B), the rotating shaft may have several mutually offset openings. In one embodiment, the starting air distributor 4 may furthermore comprise a phase shifter. The phase shifter may allow the intermittent feed of charge air at a different rotational angle of the crankshaft of the internal combustion engine than the intermittent feed of starting air. Optionally, in this embodiment, the switching valve 3 may be a check valve.

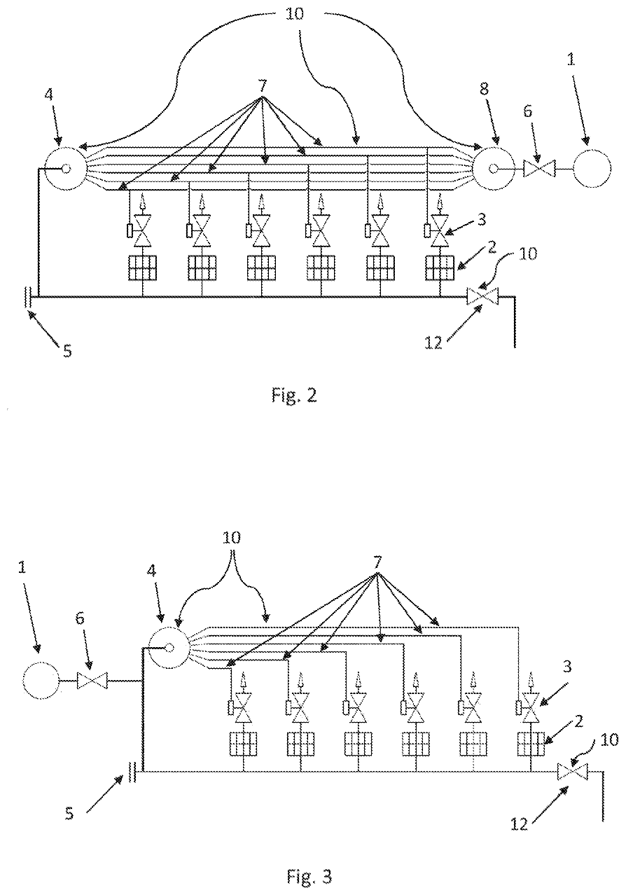

According to one embodiment, the starting air system 10 may furthermore comprise a charge air distributor 8. The charge air distributor 8 may in particular be present in addition to the starting air distributor 4. The charge air receiver 1 and the charge air distributor 8 may be connected together via a charge air supply line. In one example embodiment, the charge air shut-off valve 6 is provided in the charge air supply line. FIG. 2 shows an embodiment in which the starting air system 10 comprises the charge air distributor 8. In particular, the starting air supply line 7 may connect the charge air distributor 8 and/or the starting air distributor 4 to the cylinder. The starting air distributor 4 may be configured for the intermittent feed of starting air to the cylinder. The charge air distributor 8 may be configured for the intermittent supply of charge air to the cylinder. If the starting air system 10 has two distributors, the starting air distributor 4 and the charge air distributor 8, in particular an opening time and an opening duration for the charge air may be set in particular according to need, independently of an opening time and opening duration for the starting air. Advantageously, the starting air distributor 4 may have a neutral position in which no air or gas may flow from the starting air supply line 7 through the starting air distributor 4, and/or the charge air distributor 8 may have a neutral position in which no air or gas may flow from the starting air supply line 7 through the charge air distributor 8. In particular in the presence of several cylinders and several connections of the starting air distributor 4 and/or charge air distributor 8 to the lines of the starting air supply line 7, the starting air distributor 4 and/or the charge air distributor 8 may have the neutral position. In one embodiment, the starting air distributor 4 and/or the charge air distributor 8 may be a rotating shaft which in particular is driven in synchrony with the crankshaft of the internal combustion engine. Optionally, in this embodiment, the switching valve 3 may be a check valve.

According to one embodiment, the charge air receiver 1 may be connected to the starting air distributor 4 via a charge air supply line 7. FIG. 3 shows an embodiment in which the charge air receiver 1 is connected to the starting air distributor 4. In one example embodiment, the charge air shut-off valve 6 is provided in the charge air supply line 7. It may be possible to shut off the starting air distributor 4, in some embodiments, during partial load operation of the internal combustion engine, such that a permanent feed of charge air is possible from the charge air receiver 1 to the starting air system 10, in particular independently of the crankshaft of the internal combustion engine. In the case of several cylinders, it may be possible to shut off the starting air distributor 4 so as to allow a permanent feed of charge air to all lines of the starting air supply line 7. The starting air valve 3 arranged in the starting air supply line 7 may be configured for the intermittent feed of charge air and/or starting air to the cylinder. The starting air valve 3 may be a switching valve, in particular an electromagnetic switching valve. The opening time and/or the opening duration of the intermittent feed of charge air from the starting air system 10 to the cylinder of the internal combustion engine may thus be set as required for each cylinder, independently of the opening time and/or opening duration of the intermittent feed of starting air. In one embodiment, the starting air distributor 4 may be configured for the intermittent feed of starting air, and the starting air valve 3 for the intermittent feed of charge air.

The air feed system, in particular the starting air system 10, may furthermore comprise a controller for intermittent actuation, i.e. opening and closing, of the starting air valve 3 for the intermittent feed of starting air and/or charge air to the cylinder.

Optionally, in each of the embodiments described herein, the air feed system may comprise a flame monitor 2. The flame monitor 2 may be arranged in at least one of the starting air feed, the starting air supply line 7 or a charge air input line leading to the charge air receiver 1. The flame monitor 2 may comprise a flame detector and a control unit for opening and closing the air feed to the cylinder, in particular for opening and closing the starting air valve 3.

Optionally, in each of the embodiments described herein, the air feed system may furthermore comprise a pressure relief valve 5 connected to the starting air system 10. The pressure relief valve 5 may be configured to divert air from the starting air system 10 when a response pressure is exceeded.

According to one embodiment, an internal combustion engine is provided, in particular an internal combustion engine with Miller timing cycle. The internal combustion engine has an air feed system according to one of the embodiments disclosed herein. Furthermore, the internal combustion engine has a cylinder, wherein the starting air system 10 is connected to the cylinder in order to feed starting air intermittently to the cylinder of the internal combustion engine during a starting process of the internal combustion engine. In some embodiments, the internal combustion engine has a multiplicity of cylinders, wherein the starting air system 10 may be connected over all cylinders via the starting air supply line 7. The starting air supply line 7 may be a braided line set and/or a multiplicity of lines.

The internal combustion engine has a compressor, in particular a turbocharger device, which is connected to the charge air receiver 1 for feeding charge air to the charge air receiver 1. The starting air system 10 may be configured to provide several mutually different times for the feed of starting air or charge air for the cylinders. The feed of starting air, in particular during a starting process of the internal combustion engine, and the feed of charge air, in particular during partial load operation of the internal combustion engine, preferably may take place at different times within the working cycle.

According to one embodiment, a method is described for operating an internal combustion engine, in particular an internal combustion engine with Miller timing cycle, wherein the internal combustion engine comprises a starting air system 10 according to one of the embodiments disclosed herein. The method comprises starting the internal combustion engine in that the starting air system 10 feeds starting air intermittently to a cylinder of the internal combustion engine. Furthermore, the method comprises a feed of charge air from the charge air receiver 1 to the starting air system 10 during partial load operation of the internal combustion engine, so that the starting air system 10 feeds charge air intermittently to the cylinder.

Advantageously, the air feed system according to one of the embodiments disclosed herein may be implemented economically in an internal combustion engine with a pre-existing charge air receiver and/or one or more pre-existing features of the starting air system 10. In particular in the presence of a charge air receiver 1 and/or one or more features of the starting air system 10, no substantial structural changes are required in order to implement the embodiments according to the present disclosure. Advantageously, the embodiments require only a small number of additional components for an internal combustion engine, giving a favorable ratio between costs and effect. The intermittent feed of charge air by the charge air receiver 1 by means of the starting air system 10 may eliminate the negative implications of the “Miller effect” or Miller timing cycle, in particular on idle and during partial load operation. In contrast to the prior art, the air feed system described herein allows elimination of the negative implications of the “Miller effect” or Miller timing cycle, in particular on idle and during partial load operation, without requiring structural changes to the inlet valve actuating mechanism or the inlet valve, and without changes to the inlet valve closure. The air feed systems described herein may advantageously also be used in internal combustion engines without Miller timing cycle, in particular at idle and during partial load operation.

Although specific embodiments have been depicted and described herein, the embodiments depicted may be suitably modified within the context of the present disclosure without deviating from the protective scope of the present application.

1. An air feed system for an internal combustion engine, wherein the air feed system comprises:
a charge air receiver for receiving charge air; and
a starting air system,
wherein the starting air system has a starting air supply line connected to a cylinder of the internal combustion engine, wherein the starting air system is configured to feed starting air intermittently to the cylinder of the internal combustion engine during a starting process of the internal combustion engine, and
wherein the charge air receiver is connected to the starting air system via a charge air shut-off valve in order to feed charge air from the charge air receiver to the starting air system during partial load operation of the internal combustion engine, such that the starting air system feeds charge air intermittently to the cylinder via the starting air supply line during partial load operation of the internal combustion engine.

2. The air feed system of claim 1, wherein the starting air system comprises a starting air valve arranged in the starting air supply line.

3. The air feed system of claim 1, wherein the charge air shut-off valve is actuated so as to block a feed of charge air to the starting air system during a starting process of the internal combustion engine and to open the feed of charge air from the charge air receiver during partial load operation of the internal combustion engine, and/or wherein the starting air system comprises a starting air shut-off valve, wherein the starting air shut-off valve is actuated so as to block a feed of starting air to the starting air system during partial load operation of the internal combustion engine and open the feed of starting air during a starting process.

4. The air feed system of claim 1, wherein the starting air system is configured for the intermittent feed of starting air and charge air to the cylinder depending on a rotational angle of a crankshaft of the internal combustion engine.

5. The air feed system of claim 4, wherein the starting air system feeds the charge air intermittently at another rotational angle of the crankshaft than the intermittent feed of starting air.

6. The air feed system of claim 1, wherein the starting air system has a starting air distributor connected to the starting air supply line for the intermittent feed of starting air from the starting air feed to the cylinder via the starting air supply line.

7. The air feed system of claim 6, wherein the charge air receiver and the starting air distributor are connected together via a charge air supply line.

8. The air feed system of claim 6, wherein the starting air distributor is configured for the intermittent feed of starting air and charge air to the cylinder.

9. The air feed system of claim 1, wherein the starting air system furthermore comprises a charge air distributor wherein the charge air receiver and the charge air distributor are connected together via a charge air supply line, and wherein the starting air supply line connects the charge air distributor to the cylinder.

10. The air feed system of claim 9, wherein the charge air distributor is configured for the intermittent feed of charge air to the cylinder.

11. The air feed system of claim 1, wherein the starting air system comprises a starting air valve arranged in the starting air supply line for the intermittent feed of starting air and/or charge air to the cylinder.

12. The air feed system of claim 11, wherein the charge air receiver and the starting air distributor are connected together via a charge air supply line.

13. The air feed system of claim 1, furthermore comprising a flame monitor arranged in at least one of the starting air feed, the starting air supply line or a charge air input line leading to the charge air receiver, wherein the flame monitor comprises a flame detector and a control unit for opening and closing the charge air feed to the cylinder.

14. An internal combustion engine comprising:
the air feed system of claim 1;
a cylinder, wherein the starting air system is connected to the cylinder in order to feed starting air intermittently to the cylinder of the internal combustion engine during a starting process of the internal combustion engine; and
a compressor connected to the charge air receiver for the feed of charge air to the charge air receiver.

15. A method for operating an internal combustion engine, wherein the internal combustion engine has a starting air system, the method comprising:
starting the internal combustion engine in that the starting air system feeds starting air intermittently to a cylinder of the internal combustion engine; and
feeding charge air from the charge air receiver to the starting air system during partial load operation of the internal combustion engine, so that the starting air system intermittently feeds charge air to the cylinder.

16. The air feed system of claim 4, wherein the starting air system is configured for the feed of charge air from or after an opening of the inlet valve of the internal combustion engine and/or before or until reaching a rotational angle of the crankshaft of 30° after a bottom dead center.

17. The air feed system of claim 8, wherein the starting air distributor further comprises a phase shifter in order to allow the intermittent feed of charge air at another rotational angle of the crankshaft of the internal combustion engine than the intermittent feed of starting air.
